(19) United States
(12) Patent Application Publication
(10) Pub. No.: US 2018/0124603 A1
(43) Pub. Date: May 3, 2018

(54) COMMUNICATION METHOD, AUTHENTICATION METHOD, TERMINAL APPARATUS, COMMUNICATION SYSTEM, AND AUTHENTICATION APPARATUS

(71) Applicant: Sharp Kabushiki Kaisha, Sakai City, Osaka (JP)

(72) Inventors: HIROMICHI TOMEBA, Sakai City (JP); RYOTA YAMADA, Sakai City (JP); KATSUYA KATO, Sakai City (JP); YASUHIRO HAMAGUCHI, Sakai City (JP)

(21) Appl. No.: 15/563,896

(22) PCT Filed: Mar. 25, 2016
(86) PCT No.: PCT/JP2016/059587

§ 371 Date: Oct. 2, 2017

(30) Foreign Application Priority Data
Apr. 2, 2015 (JP) 2015-075554

(51) Int. Cl. H04W 12/06; H04W 48/18; H04W 28/18; H04W 28/24; H04W 72/04; G06K 19/07

(52) U.S. Cl. CPC H04W 12/06; H04W 48/18; G06K 19/07; H04W 28/24; H04W 72/04; H04W 28/18

(57) ABSTRACT

There are provided a communication method, an authentication method, a terminal apparatus, a communication system, and an authentication apparatus for improving communication quality and a communication opportunity capture rate under an environment in which terminal apparatuses cluster within a two-dimensionally narrow range. The communication method of this invention is a communication method for providing a communication service associated with a principal service to a terminal apparatus, including a step of providing the communication service on the basis of information on the principal service provided to the terminal apparatus. The information on the principal service provided to the terminal apparatus is a grade of the principal service.

### TECHNICAL FIELD

The present invention relates to a communication method, an authentication method, a terminal apparatus, a communication system, and an authentication apparatus.

### BACKGROUND ART

There is a need for a 5th generation mobile radio communication system (5G system) to satisfy requirements based on all use cases (service scenes and usage scenes), including a cellular service expected from a 4th generation mobile radio communication system typified by Long Term Evolution (LTE) (see NPL 1).

One of possible use cases for a 5G system is a use case where communication terminal apparatuses, typified by a smartphone, cluster within a two-dimensionally narrow range. NPL 2 describes that a 5G system is expected to support high-quality radio communication in an arena, such as a stadium, which attracts many spectators.

### CITATION LIST

### Non Patent Literature

NPL 1: ARIB White Paper, “Mobile communication systems for 2020 and beyond”, October 2014

NPL 2: NGMN White Paper, “NGMN 5G WHITE PAPER”, February 2015

### SUMMARY OF INVENTION

### Technical Problem

However, there is a limit to radio resources (frequency, time, and space) used for radio communication. If communication terminal apparatuses clustering within a two-dimensionally narrow range start communication at one time, most of the communication terminal apparatuses may become unable to communicate along with depletion of the radio resources.

The present invention has been made in view of the above-described circumstances, and has its object to provide a communication method, an authentication method, a terminal apparatus, a communication system, and an authentication apparatus which improve communication quality and a communication opportunity capture rate under an environment in which terminal apparatuses cluster within a two-dimensionally narrow range.

### Solution to Problem

To solve the above-described problem, a communication method, an authentication method, a terminal apparatus, a communication system, and an authentication apparatus according to the present invention are constituted in the manners below.

(1) That is, a communication method of the present invention is a communication method for providing a communication service associated with a principal service to a terminal apparatus, including a step of providing the communication service on the basis of information on the principal service provided to the terminal apparatus.

(2) A communication method of the present invention is the communication method according to (1) above, in which the information on the principal service provided to the terminal apparatus is a grade of the principal service.

(3) A communication method of the present invention is the communication method according to (2) above, including a step of determining a grade of the communication service provided to the terminal apparatus on the basis of the grade of the principal service.

(4) A communication method of the present invention is the communication method according to (3) above, including a step in which a resource to be allocated to the terminal apparatus is determined on the basis of the grade of the communication service.

(5) A communication method of the present invention is the communication method according to (3) above, including a step in which communication speed quality to be provided to the terminal apparatus is determined on the basis of the grade of the communication service.

(6) A communication method of the present invention is the communication method according to (3) above, including a step in which a RAT, by which the terminal apparatus is to be accommodated, is determined on the basis of the grade of the communication service.

(7) A communication method of the present invention is the communication method according to (3) above, including a step of limiting the number of terminal apparatuses constituting the terminal apparatus, to which the communication service with a prescribed grade is to be provided, to a prescribed number.

(8) An authentication method of the present invention is an authentication method for authenticating a terminal apparatus for a principal service, including a step of providing information on a communication service based on the principal service to the terminal apparatus.

(9) An authentication method of the present invention is the authentication method according to (8) above, including a step of including the information on the communication service in an authentication medium which provides information on the principal service to the terminal apparatus.

(10) An authentication method of the present invention is the authentication method according to (9) above, in which the authentication medium a gate system, and the authentication method includes a step in which the information on the communication service is provided from the gate system to the terminal apparatus that is judged by the gate system to be already authenticated.

(11) An authentication method of the present invention is the authentication method according to (9) above, in which the authentication medium is an card, and the authentication method includes a step in which the IC card is connected to the terminal apparatus and a step in which the information on the communication service is provided from the connected IC card to the terminal apparatus.

(12) A terminal apparatus of the present invention is a terminal apparatus for being authenticated for a principal service, including means for being authenticated for the principal service and means for acquiring information on a communication service based on the principal service on the basis of authentication for the principal service.

(13) A communication system of the present invention is a communication system for providing a communication service associated with a principal service to a terminal apparatus, including means for performing authentication of the terminal apparatus for the principal service, means for providing information on the communication service based on the principal service to the terminal apparatus subjected to the authentication, and means for providing the communication service to the terminal apparatus on the basis of information on the principal service provided to the terminal apparatus.

(14) An authentication apparatus of the present invention is an authentication apparatus used for authentication of a terminal apparatus for a principal service, in which information on a communication service based on the principal service is provided to the terminal apparatus.

(15) An authentication apparatus of the present invention is the authentication apparatus according to (14) above, further including communication means, in which the information on the communication service based on the principal service is provided to the terminal apparatus on the basis of the communication means.

### Advantageous Effects of Invention

According to the present invention, there are provided a communication method, an authentication method, a terminal apparatus, a communication system, and an authentication apparatus which improve communication quality and a communication opportunity capture rate under an environment in which terminal apparatuses cluster within a two-dimensionally narrow range. This improves the communication quality and the communication opportunity capture rate of a terminal apparatus and, in turn, implements an improvement in throughput.

### BRIEF DESCRIPTION OF DRAWINGS

FIG. 1 is a schematic diagram showing an example of a communication system according to the present invention.

FIG. 2 is a schematic block diagram showing a constitution example of a base station apparatus according to the present invention.

FIG. 3 is a schematic block diagram showing d constitution example of a terminal apparatus according to the present invention.

FIG. 4 is schematic diagrams showing an example of an embodiment of the present invention.

FIG. 5 is a schematic diagram showing an example of a modification of the present invention.

FIG. 6 is a schematic diagram showing an example of a modification of the present invention.

FIG. 7 is a schematic diagram showing an example of the communication system according to the present invention.

FIG. 8 is a schematic diagram showing an example of the terminal apparatus according to the present invention.

FIG. 9 is a schematic diagram showing an example of the communication system according to the present invention.

### DESCRIPTION OF EMBODIMENTS

A communication system according to the present embodiment includes a base station apparatus (a transmission apparatus, a cell, a transmission point, a transmit antenna group, a transmit antenna port group, a component carrier, or an eNodeB) and a terminal apparatus (a terminal, a mobile terminal, a reception point, a receiving terminal, a reception apparatus, a receive antenna group, a receive antenna port group, or a UE).

In the present embodiment, “X/Y” means “X or Y”. In the present embodiment, “X/Y” also means “X and Y”. In the present embodiment, “X/Y” further means “X and/or Y”.

### 1. First Embodiment

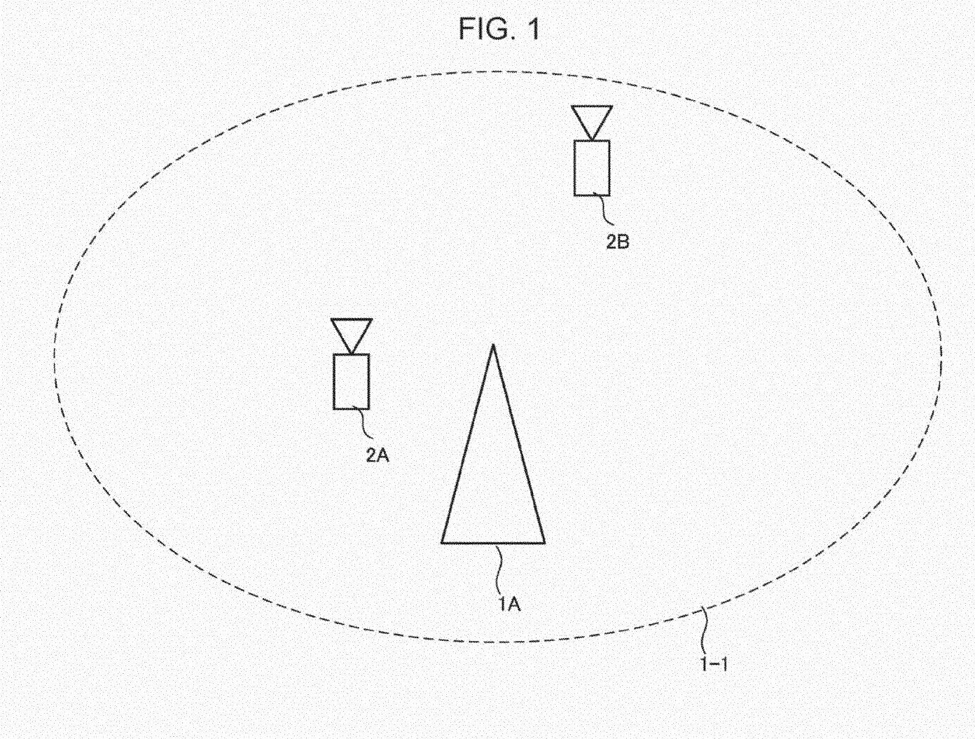

FIG. 1 is a diagram showing an example of a communication system according to the present embodiment. As shown in FIG. 1, the communication system according to the present embodiment includes a base station apparatus 1A and terminal apparatuses 2A and 2B. Coverage 1-1 is a range (communication area) where the base station apparatus 1A is connectable to a terminal apparatus. The terminal apparatuses 2A and 2B are collectively referred to as terminal apparatuses 2.

The base station apparatus 1A and the terminal apparatuses 2A and 2B of the communication system according to the present embodiment include at least a part of the communication method to be described below. The communication system according to the present embodiment may include a base station apparatus other than the base station apparatus 1A and a terminal apparatus other than the terminal apparatuses 2A and 2B.

In FIG. 1, the following uplink physical channels are used for uplink radio communication from the terminal apparatus 2A to the base station apparatus 1A. The uplink physical channels are used to transmit information which is output from a higher layer.

The physical uplink control channel (PUCCH)

The physical uplink shared channel (PUSCH)

The physical random access channel (PRACH)

The PUCCH is used to transmit uplink control information (UCI). The uplink control information here includes a positive acknowledgement (ACK) or a negative acknowledgement (HACK) (ACK/NACK) of downlink data (a downlink transport block, the downlink-shared channel (DL-SCH)). The ACK/NACK of the downlink data is also referred to as an HARQ-ACK or HARQ feedback.

The uplink control information also includes channel state information (CSI) of downlink. The uplink control information also includes a scheduling request (SR) used to request a resource of the uplink-shared channel (UL-SCH). The channel state information corresponds to a rank indicator RI specifying the preferred number of spatial multiplexing, a precoding indicator PMI specifying a preferred precoder, a channel quality indicator CQI specifying a preferred transmission rate, and the like.

The channel quality indicator CQI (hereinafter referred to as a CQI value) can be a preferred modulation scheme (for example, QPSK, 16-QAM, 64-QAM, or 256-QAM) or a code rate in a prescribed band (to be described in detail later). The CQI value can be an index (CQI index) set by the change scheme or the code rate. The CQI value can be a value set in advance in the system.

Note that the rank indicator and the precoding quality indicator can be set in advance by the system. The rank indicator and the precoding matrix indicator can be indices set by the number of spatial multiplexing and precoding matrix information. Note that values of the rank indicator, the preceding matrix indicator, and the channel quality indicator CQI are collectively referred to as CSI values.

The PUSCH is used to transmit uplink data (an uplink transport block, the UL-SCH). The PUSCH may be used to transmit the ACK/NACK and/or the channel state information together with the uplink data. The PUSCH may be used to transmit only the uplink control information.

The PUSCH is also used to transmit an RRC message. The RRC message is a piece of information/signal processed in the radio resource control (RRC) layer. The PUSCH is used to transmit a MAC control element (CE). The MAC CE here is a piece of information/signal processed (transmitted) in the medium access control (MAC) layer.

For example, a power headroom may be included in the MAC CE and be reported via the PUSCH. That is, a MAC CE field may be used to indicate the level of the power headroom.

The PRACH is used to transmit a random access preamble.

In uplink radio communication, an uplink reference signal (UL RS) is used as an uplink physical signal. An uplink physical signal is not used to transmit information output from the higher layer but is used by the physical layer. The uplink reference signal here includes a demodulation reference signal (DMRS) and a sounding reference signal (SR).

The DMRS is connected with transmission of the PUSCH or the PUCCH. For example, the base station apparatus 1A uses the DMRS to perform channel correction on the PUSCH or the PUCCH. The SRS is not connected with transmission of the PUSCH or the PUCCH. For example, the base station apparatus 1A uses the SRS to measure an uplink channel state.

In FIG. 1, downlink radio communication from the base station apparatus 1A to the terminal apparatus 2A uses the following downlink physical channels. The downlink physical channels are used to transmit information output from the higher layer.

The physical broadcast channel (PBCH: a broadcast channel)

The physical control format indicator channel (PCFICH: a control format indicator channel)

The physical hybrid automatic repeat request indicator channel (PHICH: an HARQ indicator channel)

The physical downlink control channel (PDCCH: a downlink control channel)

The enhanced physical downlink control channel (EPDCCH: an enhanced downlink control channel)

The physical downlink shared channel (PDSCH: a downlink shared channel)

The PBCH is used to broadcast a master information block (MIB, a broadcast channel (BCH)) shared by the terminal apparatuses. The PCFICH is used to transmit information indicating a region used for transmission of the PDCCH (for example, the number of OFDM symbols).

The PHICH is used to transmit an ACK/NACK of the uplink data (a transport block or a codeword) received by the base station apparatus 1A. That is, the PHICH is used to transmit an HARQ indicator (HARQ feedback) indicating the ACK/NACK of the uplink data. The ACK/NACK is also referred to as an HARQ-ACK. The terminal apparatus 2A notifies a higher layer of the received ACK/NACK. The ACK of the ACK/NACK indicates correct reception, and the NACK indicates incorrect reception. DTX indicates that there is no corresponding data. If there is no PHICH for the uplink data, the terminal apparatus 2A notifies the higher layer of the ACK.

The PDCCH and the EPDCCH are used to transmit downlink control information (DCI). Here, a plurality of DCI formats are defined for transmission of the downlink control information. That is, fields for the downlink control information are defined in the DCI formats and are mapped to information bits.

For example, a DCI format 1A used for scheduling of one PDSCH (transmission of one downlink transport block) in one cell is defined as a DCI format for the downlink.

For example, a DCI format for downlink includes information on PDSCH resource allocation, information on a modulation and coding scheme (MCS) for the PDSCH, and the downlink control information, such as a TPC command, for the PUCCH. The DCI format for downlink here is also referred to as a downlink grant (or a downlink assignment).

For example, a DCI format 0 used for scheduling of one PUSCH (transmission of one uplink transport block) in one cell is defined as a DCI format for uplink.

For example, a DCI format for uplink includes information on PUSCH resource allocation, information on an MCS for the PUSCH, and the uplink control information, such as a TPC command for the PUSCH. The DCI format for uplink is also referred to as an uplink grant (or an uplink assignment).

The DCI format for uplink can be used to make a request (CSI request) for channel state information (CSI; also referred to as reception quality information) of downlink. The channel state information corresponds to a rank indicator RI specifying the preferred number of spatial multiplexing, a precoding matrix indicator PMI specifying a preferred precoder, a channel quality indicator specifying a preferred transmission rate, a precoding type indicator PTI, and the like.

The DCI format for uplink can be used for a constitution indicating an uplink resource, to which a channel state information report (CSI feedback report) fed back from the terminal apparatus to the base station apparatus is mapped. For example, the channel state information report can be used for a constitution indicating an uplink resource, to which periodic channel state information (periodic CSI) is reported. The channel state information report can be used to configure a mode of periodically reporting channel state information (CSI report mode).

For example, the channel state information report can be used for a constitution indicating an uplink resource, to which aperiodic channel state information (aperiodic CSI) is reported. The channel state information report can be used to configure a mode of aperiodically reporting channel state information (CSI report mode). The base station apparatus can configure the periodic channel state information report or the aperiodic channel state information report. The base station apparatus can configure both the periodic channel state information report and the aperiodic channel state information report.

The DCI format for uplink can be used for a constitution indicating the type of the channel state information report fed back from the terminal apparatus to the base station apparatus. Examples of the type of the channel state information report include broadband CSI (for example, a wideband CQI) and narrowband CSI (for example, a subband CQI).

When a resource of the PDSCH is scheduled using the downlink assignment, the terminal apparatus receives downlink data via the scheduled PDSCH. When a resource of the PUSCH is scheduled using the uplink grant, the terminal apparatus transmits uplink data and/or uplink control information via the scheduled PUSCH.

The PDSCH is used to transmit downlink data (a downlink transport block, the DL-SCH). The PDSCH is used to transmit a system information block type message. The system information block type 1 message is cell-specific information.

The PDSCH is also used to transmit a system information message. The system information message includes a system information block X of a type other than the system information block type 1. The system information message is cell-specific information.

The PDSCH is further used to transmit an RRC message. The RRC message transmitted from the base station apparatus here may be common to a plurality of terminal apparatuses within a cell. An RRC message transmitted from the base station apparatus 1A may be a message dedicated to a given terminal apparatus 2 (also referred to as dedicated signaling). That is, user apparatus-specific information is transmitted using a message dedicated to the given terminal apparatus. The PDSCH is used to transmit a MAC CE.

Here, an RRC message and/or a MAC CE is also referred to as higher layer signaling.

The PDSCH can be used to request channel state information of downlink. The PDSCH can be used to transmit an uplink resource, to which a channel state information report (CSI feedback report) fed back from the terminal apparatus to the base station apparatus is mapped. For example, the channel state information report can be used for a constitution indicating an uplink resource, to which periodic channel state information (periodic CSI) is reported. The channel state information report can be used to configure a mode of periodically reporting the channel state information (CSI report mode).

Examples of the type of the downlink channel state information report include broadband CSI (for example, wideband CSI) and narrowband CSI (for example, subband CSI). In the case of the broadband CSI type, one piece of channel state information is calculated for a system band of a cell. In the case of the narrowband CSI type, the system band is partitioned into prescribed units, and one piece of channel state information is calculated for each unit.

In downlink radio communication, a synchronization signal (SS) and a downlink reference signal (DL RS) are used as downlink physical signals. The downlink physical signals are not used to transmit information output from the higher layer but are used by the physical layer.

The synchronization signal is used by the terminal apparatus to synchronize between a downlink frequency domain and a downlink time domain. The downlink reference signal is used by the terminal apparatus to perform channel correction on the downlink physical channels. For example, the downlink reference signal is used by the terminal apparatus to calculate downlink channel state information.

Here, the downlink reference signal includes a cell-specific reference signal (CRS), a UE-specific reference signal (URS) connected with the PDSCH, a demodulation reference signal (DMRS) connected with the EPDCCH, a non-zero power channel state information-reference signal (NZP CSI-RS), and a zero power channel state information-reference signal (ZP CSI-RS).

The CRS is transmitted over all bands of a subframe and is used to demodulate the PBCH/PDCCH/PHICH/PCFICH/PDSCH. The URS connected with the PDSCH is transmitted in a subframe and a band used for transmission of the PDSCH, with which the URS is connected, and is used to demodulate the PDSCH, with which the URS is connected.

The DMRS connected with the EPDCCH is transmitted in a subframe and a band used for transmission of the EPDCCH, with which the DMRS is connected. The DMRS is used to demodulate the EPDCCH, with which the DMRS is connected.

A resource of the NZP CSI-RS is configured by the base station apparatus 1A. For example, the terminal apparatus 2A performs signal measurement (channel measurement) using the NZP CSI-RS. A resource of the ZP CSI-RS is configured by the base station apparatus 1A. The base station apparatus 1A transmits the ZP CSI-RS with zero power. For example, the terminal apparatus 2A measures interference in a resource, to which the NZP CSI-RS corresponds.

A multimedia broadcast multicast service single frequency network (MBSFN) RS is transmitted over all bands of a subframe used for transmission of the PMCH. The MBSFN RS is used to demodulate the PMCH. The PMCH is transmitted via an antenna port used for transmission of the MBSFN RS.

Here, downlink physical channels and downlink physical signals are also collectively referred to as downlink signals. Uplink physical channels and uplink physical signals are also collectively referred to as uplink signals. Downlink physical channels and uplink physical channels are also collectively referred to as physical channels. Downlink physical signals and uplink physical signals are also collectively referred to as physical signals.

The BCH, the UL-SCH, and the DL-SCH are transport channels. A channel used in the MAC layer is referred to as a transport channel. A unit for the transport channel used in the MAC layer is referred to as a transport block (TB) or a MAC protocol data unit (PDU). The transport block is a unit of data which the MAC layer passes (delivers) to the physical layer. In the physical layer, transport blocks are mapped to codewords, and coding processing and the like are performed on each codeword.

The base station apparatus 1A can allocate resources typified by time, frequency, and space (for example, an antenna port, a beam pattern, and a precoding pattern) to the terminal apparatuses 2A and 2B. The terminal apparatuses 2A and 2B can use resources allocated to the base station apparatus 1A. With the above-described operation, the base station apparatus 1A can multiplex the terminal apparatuses 2A and 2B. As described earlier, the present invention is not limited to this, and three or more terminal apparatuses may be multiplexed.

By a conventional method, a base station apparatus can determine a resource allocation method on the basis of communication with a terminal apparatus. For example, the base station apparatus can determine a resource allocation method on the basis of information indicating the reception quality of a terminal apparatus fed back from the terminal apparatus. The base station apparatus can improve the throughput of a communication system by allocating resources to a terminal apparatus with good reception quality while giving priority to the terminal apparatus. However, if the number of terminal apparatuses connected to the base station apparatus is enormous, the base station apparatus determines a resource allocation method on the basis of pieces of information indicating reception quality, of which the plurality of terminal apparatuses notify the base station apparatus. This increases the burden of resource allocation on the base station apparatus. Additionally, if the base station apparatus performs resource allocation on the basis of reception quality, the communication speed of each terminal apparatus is a best-effort speed. This leads to a situation where only a few resources are allocated to a terminal apparatus requesting a truly high communication speed.

The base station apparatus 1A according to the present embodiment can determine a resource allocation method on the basis of information other than information on communication with the terminal apparatus 2. For example, prior to actual data communication, the base station apparatus 1A can determine resources to be allocated to the terminal apparatuses 2A and 2B in advance. Resources, allocation of which can be determined in advance by the base station apparatus 1A, include resources related to multiple access. For example, the base station apparatus 1A can allocate, in advance, time resources (an occupied time, an allocation period, a time slot, a subframe, and a frame), frequency resources (an occupied bandwidth, a frequency hopping pattern, a carrier frequency, a subcarrier, a subband, and a resource block), code resources (a spread code, a spread code generation parameter, and a spread code generation expression), and space resources (an antenna port number, a beam identification number, and a precoding identification number) to the terminal apparatuses 2A and 2B. Additionally, the base station apparatus 1A can allocate, in advance, pieces of information for identification of the terminal apparatuses 2A and 2B (a scrambling code, a scrambling code generation parameter, and a user ID) to the terminal apparatuses 2A and 2B. In addition, the base station apparatus 1A can determine, in advance, the communication speeds of the terminal apparatuses 2A and 2B.

The base station apparatus 1A can use priorities provided in advance to the terminal apparatuses 2A and 2B as pieces of information serving as criteria for determining resource allocation. As the prior provided in advance to the terminal apparatuses 2A and 2B, the base station apparatus to can use, for example, pieces of information indicating costs (prices, communication fees, usage fees, and contract fees) paid to the communication system according to the present embodiment by the terminal apparatuses 2A and 2B. For example, assume that the base station apparatus 1A allocates, in advance, resource occupied times to the terminal apparatuses 2A and 2B. If the terminal apparatus 2A pays a higher cost to the communication system than the terminal apparatus 2B, the base station apparatus 1A can make a resource occupied time for the terminal apparatus 2A longer than that for the terminal apparatus 2B. Alternatively, the base station apparatus 1A may relatively evaluate costs paid by the terminal apparatuses 2 through comparison between the terminal apparatuses 2A and 2B or may absolutely evaluate the costs with reference to a prescribed threshold.

As has been described above, since the base station apparatus 1A can determine resource allocation to the terminal apparatuses 2 on the basis of information other than information on communication, the base station apparatus 1A can determine resource allocation more easily than by a conventional method.

The communication system according to the present embodiment can allocate, in advance, available radio access technologies (RATs) to the terminal apparatuses 2A and 2B. For example, the communication system according to the present embodiment can use two RATs (a first RAT and a second RAT). The base station apparatus 1A can support both the first and second RATs. If the base station apparatus 1A supports the first RAT, the communication system according to the present embodiment can newly include a base station apparatus 1B which supports the second RAT.

If the base station apparatus 1A supports the first and second RATs, the base station apparatus 1A can accommodate the terminal apparatus 2A higher in paid cost using the first RAT and accommodate the terminal apparatus 2B lower in paid cost using the second RAT. Here, the base station apparatus 1A can use, for example, LTE as the first RAT and a wireless local area network (wireless LAN) as the second RAT.

If the communication system according to the present embodiment includes a plurality of base station apparatuses supporting different RATs, the communication system can further include a radio network management station (radio network controller (RNC)). The RNC can determine base station apparatuses to accommodate the terminal apparatuses 2A and 2B on the basis of costs paid to the communication system by the terminal apparatuses 2A and 2B.

The communication system according to the present embodiment can provide different service quality (communication speed quality) to each terminal apparatus 2 on the basis of a cost paid by the terminal apparatus 2. For example, the communication system can provide two types of service quality (first service quality and second service quality) to the terminal apparatus 2. The base station apparatus 1A can provide the two types of service quality to the terminal apparatus 2. The base station apparatus 1A can provide the first service quality to the terminal apparatus 2A higher in paid cost and provide the second service quality to the terminal apparatus 2B lower in paid cost. Here, the base station apparatus 1A can provide, as the first service quality, minimum guaranteed service quality that guarantees a prescribed communication speed. The base station apparatus 1A can also provide, as the second service quality, best-effort service quality.

The base station apparatus 1A according to the present embodiment can control a connection delay (latency) which the terminal apparatus 2 tolerates on the basis of a cost paid by the terminal apparatus 2. For example, the base station apparatus 1A can provide a communication service short in connection delay to the terminal apparatus 2 that has paid a prescribed cost. The base station apparatus 1A can also accommodate the terminal apparatus 2 that has paid the prescribed cost using a RAT short in connection delay.

The base station apparatus 1A according to the present embodiment can accommodate more than two terminal apparatuses 2. As described earlier, if the base station apparatus 1A can provide a plurality of RATs and a plurality of types of service quality, the base station apparatus 1A can determine the number of terminal apparatuses which can be accommodated by each RAT and the number of terminal apparatuses, to which each type of service quality can be provided, on the basis of costs paid by the terminal apparatuses 2. For example, the base station apparatus 1A that can use the first and second RATs can accommodate terminal apparatuses 2, the number of which is a prescribed accommodation number for the first RAT, in descending order of aid cost using the first RAT.

The base station apparatus 1A can accommodate the terminal apparatus 2 that has paid the prescribed cost, using the first RAT. If the number of terminal apparatuses 2 that have paid the prescribed cost exceeds the prescribed accommodation number for the first RAT, the base station apparatus 1A can determine the terminal apparatuses 2 to be accommodated by the first RAT on the basis of another type of information. The base station apparatus 1A can determine the terminal apparatuses 2 to be accommodated by the first RAT on the basis of the times required for the terminal apparatuses 2 to pay the prescribed cost. In other words, the base station apparatus 1A can determine the terminal apparatuses 2 to be accommodated by the first RAT on the basis of the order of payments of the prescribed cost made (the intentions to pay the prescribed cost expressed) by the terminal apparatuses 2. In still other words, the communication system (the base station apparatus 1A) according to the present embodiment can also use the time required for each terminal apparatus 2 to pay the prescribed cost as information used to determine a RAT, by which the terminal apparatus 2 is to be accommodated, and service quality to be provided to the terminal apparatus 2 (that is, information indicating a cost).

As has been described above, since the base station apparatus 1A can determine a RAT, by which the terminal apparatus 2 is to be accommodated, and service quality to be provided to the terminal apparatus 2 on the basis of information other than information on communication, the base station apparatus 1A can flexibly and easily accommodate the terminal apparatuses 2.

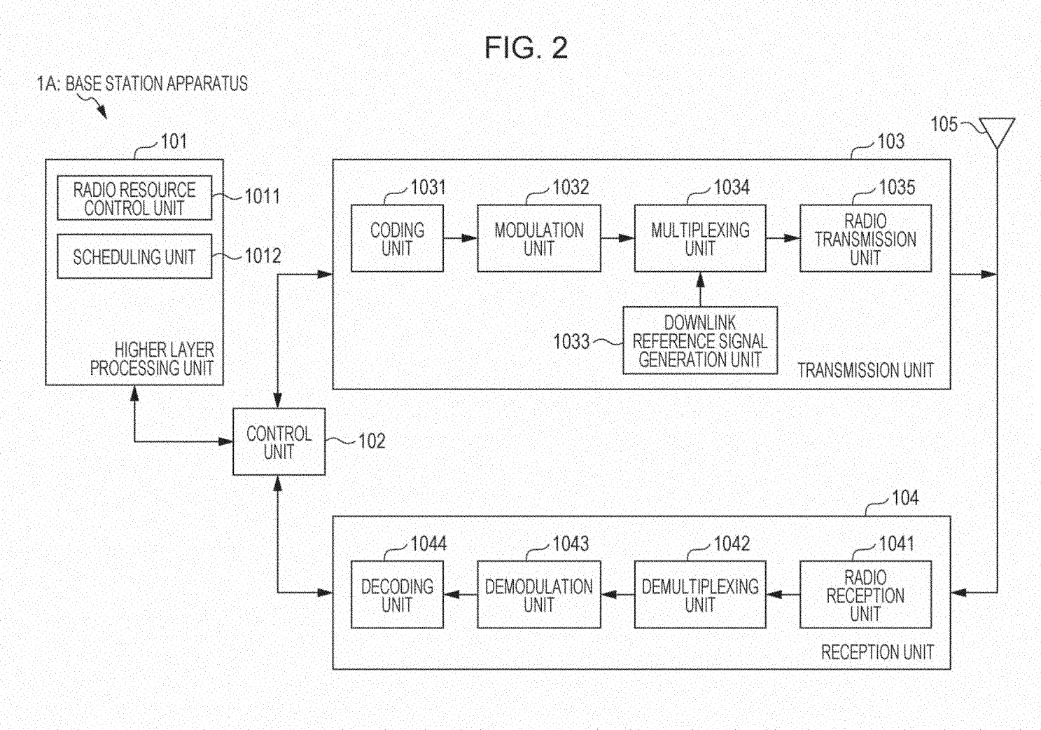

FIG. 2 is schematic block diagram showing the constitution of the base station apparatus 1A according to the present embodiment. As shown in FIG. 2, the base station apparatus 1A includes a higher layer processing unit (higher layer processing step) 101, a control unit (control step) 102, a transmission unit (transmission step) 103, a reception unit (reception step) 104, and a transmit/receive antenna 105. The higher layer processing unit 101 includes a radio resource control unit (radio resource control step) 1011 and a scheduling unit (scheduling step) 1012. The transmission unit 103 includes a coding unit (coding step) 1031, a modulation unit (modulation step) 1032, a downlink reference signal generation unit (downlink reference signal generation step) 1033, a multiplexing unit (multiplexing step) 1034, and a radio transmission unit (radio transmission step) 1035. The reception unit 104 includes a radio reception unit (radio reception step) 1041, a demultiplexing unit (demultiplexing step) 1042, a demodulation unit (demodulation step) 1043, and a decoding unit (decoding step) 1044.

The higher layer processing unit 101 performs processing for the medium access control (MAC) layer, the packet data convergence protocol (PDCP) layer, the radio link control (RLC) layer, and the radio resource control (RRC) layer. The higher layer processing unit 101 also generates information needed to control the transmission unit 103 and the reception unit 104 and outputs the generated information to the control unit 102.

The higher layer processing unit 101 receives information on a terminal apparatus, such as the capability (UE capability) of the terminal apparatus, from the terminal apparatus. In other words, a terminal apparatus transmits its capability to a base station apparatus using a higher layer signal.

Note that, in the description below, information on a terminal apparatus includes information indicating whether the terminal apparatus supports a prescribed capability or information indicating that the terminal apparatus has completed introduction and testing of the prescribed capability. Note that, in the description below, whether a prescribed capability is supported includes whether introduction and testing of the prescribed capability have been completed.

For example, if a terminal apparatus supports a prescribed capability, the terminal apparatus transmits a piece of information (parameter) indicating whether the prescribed capability is supported. If the terminal apparatus does not support the prescribed capability, the terminal apparatus does not transmit a piece of information (parameter) indicating whether the prescribed capability is supported. That is, notification of whether the prescribed capability is supported is given by whether a piece of information (parameter) indicating whether the prescribed capability is supported is transmitted. Note that notification of the piece of information (parameter) indicating whether the prescribed capability is supported may be given using one bit of 1 or 0.

The radio resource control unit 1011 generates downlink data (a transport block), system information, an RRC message, a MAC CE, and the like which are to be mapped to the PDSCH of downlink or acquires the pieces of information from a higher node. The radio resource control unit 1011 outputs the downlink data to the transmission unit 103 and outputs the other pieces of information to the control unit 102. The radio resource control unit 1011 manages various types of configuration information of a terminal apparatus.

The scheduling unit 1012 determines frequencies and subframes, to which physical channels (the PDSCH and the PUSCH) are to be assigned, code rates and modulation schemes (or MCSs) for the physical channels (the PDSCH and the PUSCH), transmit power, and the like. The scheduling unit 1012 outputs the determined pieces of information to the control unit 102.

The scheduling unit 1012 generates information used for scheduling of the physical channels (the PDSCH and the PUSCH) on the basis of a scheduling result. The scheduling unit 1012 outputs the generated information to the control unit 102.

The control unit 102 generates control signals for controlling the transmission unit 103 and the reception unit 104 on the basis of information input from the higher layer processing unit 101. The control unit 102 generates downlink control information on the basis of the information input from the higher layer processing unit 101 and outputs the downlink control information to the transmission unit 103.

In accordance with a control signal input from the control unit 102, the transmission unit 103 generates a downlink reference signal, codes and modulates an HARQ indicator, downlink control information, and downlink data which are input from the higher layer processing unit 101, multiplexes the PHICH, the PDCCH, the EPDCCH, the PDSCH, and the downlink reference signal, and transmits the resultant signal to the terminal apparatus 2 via the transmit/receive antenna 105.

The coding unit 1031 codes the HARQ indicator, the downlink control information, and the downlink data input from the higher layer processing unit 101 using a coding scheme set in advance, such as block coding, convolutional coding, or turbo coding, or using a coding scheme determined by the radio resource control unit 1011. The modulation unit 1032 modulates coding bits input from the coding unit 1031 using a modulation scheme, such as binary phase shift keying (BPSK), quadrature phase shift keying (QPSK), 16-quadrature amplitude modulation (16-QAM), 64-QAM, or 256-QAM, set in advance or determined by the radio resource control unit 1011.

The downlink reference signal generation unit 1033 generates, as a down-link reference signal, a sequence known to the terminal apparatus 2A which is obtained by a rule set in advance on the basis of a physical cell identifier (PCI or cell ID) for identification of the base station apparatus 1A, and the like.

The multiplexing unit 1034 multiplexes a modulation symbol modulated of each channel, the generated downlink reference signal, and the downlink control information. That is, the multiplexing unit 1034 maps the modulation symbol modulated of each channel, the generated downlink reference signal, and the downlink control information to resource elements.

The radio transmission unit 1035 performs an inverse fast Fourier transform (IFFT) on the multiplexed modulation symbol and the like to generate an OFDM symbol, adds a cyclic prefix (CP) to the OFDM symbol to generate a baseband digital signal, converts the baseband digital signal into an analog signal, removes an excess frequency component through filtering, up-converts the signal to a carrier frequency, performs power amplification, and outputs the resultant signal to the transmit/receive antenna 105 for transmission.

In accordance with a control signal input from the control unit 102, the reception unit 104 demultiplexes, demodulates, and decodes a received signal received from the terminal apparatus 2A via the transmit/receive antenna 105 and outputs decoded information to the higher layer processing unit 101.

The radio reception unit 1041 converts an uplink signal received via the transmit/receive antenna 105 into a baseband signal through down-conversion, removes an unnecessary frequency component, controls amplification level such that the signal level is appropriately maintained, performs quadrature demodulation on the basis of an in-phase component and a quadrature component of the received signal, and converts an analog signal obtained through the quadrature demodulation into a digital signal.

The radio reception unit 1041 removes a part corresponding to a CP from the digital signal obtained through the conversion. The radio reception unit 1041 performs a fast Fourier transform (FFT) on the signal, from which the CP has been removed, and extracts a signal in a frequency domain to output the resultant signal to the demultiplexing unit 1042.

The demultiplexing unit 1042 demultiplexes the signal input from the radio reception unit 1041 into signals, such as the PUCCH, the PUSCH, and an uplink reference signal. Note that the demultiplexing is performed on the basis of radio resource allocation information included in the uplink grant, which is determined in advance by the base station apparatus 1A with the radio resource control unit 1011 and is notified to each terminal apparatus 2.

The demultiplexing unit 1042 also performs channel compensation on the PUCCH and the PUSCH. The demultiplexing unit 1042 further demultiplexes the uplink reference signal.

The demodulation unit 1043 performs an inverse discrete Fourier transform (IDFT) on the PUSCH, acquires modulation symbols, and performs received signal demodulation for each of modulation symbols of the PUCCH and the PUSCH using a modulation scheme, such as BPSK, QPSK, 16-QAM, 64-QAM, or 256-QAM, which is set in advance or of which the own apparatus notifies each terminal apparatus 2 in advance through the uplink grant.

The decoding unit 1044 decodes coding bits of the demodulated PUCCH and PUSCH at a code rate, which is set in advance or of which the own apparatus notifies the terminal apparatus 2 in advance through the uplink grant, in a coding scheme set in advance and outputs decoded uplink data and uplink control information to the higher layer processing unit 101. In the case of retransmission of the PUSCH, the decoding unit 1044 forms decoding using coding bits input from the higher layer processing unit 101 and held in an HARQ buffer and the demodulated coding bits.

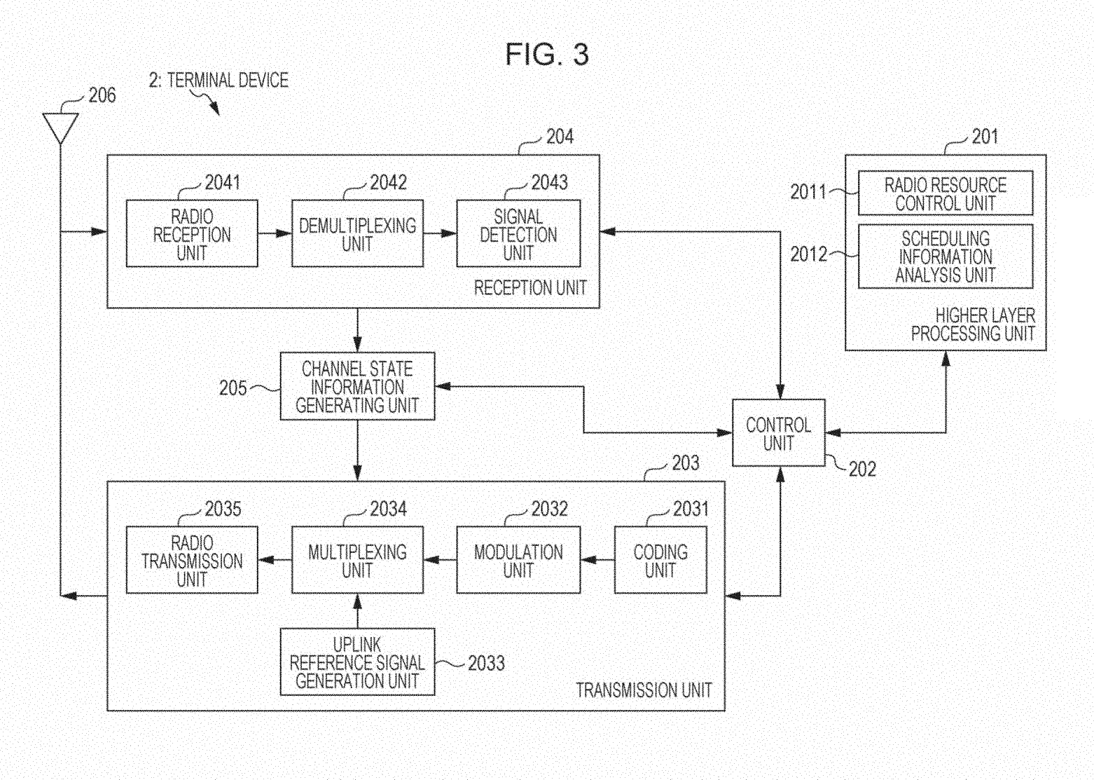

FIG. 3 is a schematic block diagram showing the constitution of the terminal apparatus 2 according to the present embodiment. As shown in FIG. 3, the terminal apparatus 2A includes a higher layer processing unit (higher layer processing step) 201, a control unit (control step) 202, a transmission unit (transmission step) 203, a reception unit (reception step) 204, a channel state information generating unit (channel state information generation step) 205, and a transmit/receive antenna 206. The higher layer processing unit 201 includes a radio resource control unit (radio resource control step) 2011 and a scheduling information analysis unit (scheduling information analysis step) 2012. The transmission unit 203 includes a coding unit (coding step) 2031, a modulation unit (modulation step) 2032, an uplink reference signal generation unit (uplink reference signal generation step) 2033, a multiplexing unit (multiplexing step) 2034, and a radio transmission unit (radio transmission step) 2035. The reception unit 204 includes a radio reception unit (radio reception step) 2041, demultiplexing unit (demultiplexing step) 2042, and a signal detection unit (signal detection step) 2043.

The higher layer processing unit 201 outputs uplink data (a transport block) which is generated by a user operation or the like to the transmission unit 203. The higher layer processing unit 201 also performs processing for the medium access control (MAC) layer, the packet data convergence protocol (PDCP) layer, the radio link control (RLC) layer, and the radio resource control (RPC) layer.

The higher layer processing unit 201 outputs information indicating a terminal apparatus capability which the own terminal apparatus supports to the transmission unit 203.

The radio resource control unit 2011 manages various types of configuration information of the own terminal apparatus. The radio resource control unit 2011 also generates information to be mapped to each uplink channel and outputs the information to the transmission unit 203.

The radio resource control unit 2011 acquires configuration information regarding CSI feedback transmitted from the base station apparatus and outputs the configuration information to the control unit 202.

The scheduling information analysis unit 2012 analyzes downlink control information received via the reception unit 204 and determines scheduling information. The scheduling information analysis unit 2012 also generates control information for controlling the reception unit 204 and the transmission unit 203 on the basis of the scheduling information and outputs the control information to the control unit 202.

The control unit 202 generates control signals for controlling the reception unit 204, the channel state information generating unit 205, and the transmission unit 203 on the basis of information input from the higher layer processing unit 201. The control unit 202 outputs the generated control signals to the reception unit 204, the channel state information generating unit 205, and the transmission unit 203 to control the reception unit 204 and the transmission unit 203.

The control unit 202 controls the transmission unit 203 to transmit CSI generated by the channel state information generating unit 205 to the base station apparatus.

In accordance with a control signal input from the control unit 202, the reception unit 204 demultiplexes, demodulates, and decodes a received signal received from the base station apparatus 1A via the transmit/receive antenna 206 and outputs decoded information to the higher layer processing unit 201.

The radio reception unit 2041 converts a downlink signal which is received via the transmit/receive antenna 206 into a baseband signal through down-conversion, removes an unnecessary frequency component, controls amplification level such that the signal level is appropriately maintained, performs quadrature demodulation on the basis of an in-phase component and a quadrature component of the received signal, and converts an analog signal obtained through the quadrature demodulation into a digital signal.

The radio reception unit 2041 removes a part corresponding to a CP from the digital signal obtained through the conversion, performs a fast Fourier transform on the signal, from which the CP has been removed, and extracts a signal in a frequency domain.

The demultiplexing unit 2042 demultiplexes the extracted signal into the PHICH, the PDCCH, the EPDCCH, the PDSCH, and a downlink reference signal. The demultiplexing unit 2042 performs channel compensation on the PHICH, the PDCCH, and the EPDCCH on the basis of a channel estimate for a desired signal obtained through channel measurement, detects downlink control information, and outputs the downlink control information to the control unit 202. The control unit 202 also outputs the PDSCH and the channel estimate for the desired signal to the signal detection unit 2043.

The signal detection unit 2043 detects a signal using the PDSCH and the channel estimate and outputs the signal to the higher layer processing unit 201.

The transmission unit 203 generates an uplink reference signal, codes and modulates uplink data (a transport block) input from the higher layer processing unit 201, multiplexes the PUCCH, the PUSCH, and the generated uplink reference signal, and transmits a resultant signal to the base station apparatus via the transmit/receive antenna 206, in accordance with a control signal input from the control unit 202.

The coding unit 2031 performs coding, such as convolutional coding or block coding, on uplink control information input from the higher layer processing unit 201. The coding unit 2031 also performs turbo coding on the basis of information used for scheduling of the PUSCH.

The modulation unit 2032 modulates coding bits input from the coding unit 2031 by a modulation scheme, such as BPSK, QPSK, 16-QAM, or 64-QAM, notification of which is given by downlink control information, or a modulation scheme which is set in advance for each channel.

The uplink reference signal generation unit 2033 generates a sequence which is obtained by a rule (expression) set in advance on the basis of a physical cell identity (also referred to as a PCI, a cell ID, or the like) for identification of the base station apparatus 1A, the width of a band to which an uplink reference signal is to be mapped, a cyclic shift, notification of which is given through the uplink grant, the value of a parameter for generation of a DMRS sequence, and the like.

In accordance with the control signal input from the control unit 202, the multiplexing unit 2034 rearranges modulation symbols of the PUSCH in parallel and then performs a discrete Fourier transform (DFT). The multiplexing unit 2034 multiplexes signals of the PUCCH and the PUSCH and the generated uplink reference signal for each transmit antenna port. That is, the multiplexing unit 2034 maps the signals of the PUCCH and the PUSCH and the generated uplink reference signal to resource elements for each transmit antenna port.

The radio transmission unit 2035 performs an inverse fast Fourier transform (IFFT) on a multiplexed signal to perform SC-FDMA modulation, generates an SC-FDMA symbol, adds a CP to the generated SC-FDMA symbol, generates a baseband digital signal, converts the baseband digital signal into an analog signal, removes an excess frequency component, converts the signal into a carrier frequency through up-conversion, performs power amplification, and outputs the resultant signal to the transmit/receive antenna 206 for transmission.

According to the base station apparatus 1A and the terminal apparatus 2 that have been described above, the base station apparatus 1A can determine resource allocation to the terminal apparatus 2 on the basis of information other than information on communication. The base station apparatus 1A can determine a RAT, by which the terminal apparatus 2 is to be accommodated, and service quality to be provided no the terminal apparatus 2. Since the base station apparatus 1A can flexibly and easily perform resource allocation and RAT and service quality selection, it is possible to implement effective resource utilization and, in turn, contribute to an improvement in the spectral efficiency of the communication system.

### 2. Second Embodiment

In the present embodiment, a base station apparatus 1A associates resources to be allocated to a terminal apparatus 2, a RAT to be used, and service quality to be provided with still another type of information. Note that the apparatus constitutions of the base station apparatus 1A and the terminal apparatus 2 are the same as those the first embodiment. Although the following description is given with a case where the base station apparatus 1A allocates resources to the terminal apparatus 2 in mind, a method according to the present embodiment is, of course, not limited to this. For example, as has been described in the first embodiment, the base station apparatus 1A can configure a RAT, by which the terminal apparatus 2 is to be accommodated, for each terminal apparatus 2 and can configure communication speed quality for each terminal apparatus 2.

A communication system and the base station apparatus 1A according to the present embodiment determine resource allocation in accordance with a business form in which a communication service is actually provided. In the present embodiment, service (principal service) which is different from a communication service provided by the communication system or the base station apparatus 1A will be described on the assumption that an entity which provides a service (an organizer, a producer, a provider, an operator, or a business operator) provides a principal service to an entity which receives a service (a customer, a consumer, or a recipient). In other words, in the present embodiment, a service providing entity provides a communication service to a service receiving entity using the communication system (the base station apparatus 1A), in addition to a principal service. The operations below that the base station apparatus 1A performs include an operation which the service providing entity performs using the base station apparatus A. A description will be given on the assumption that a service receiving entity includes the terminal apparatus 2 according to the present embodiment. The operations below performed by the terminal apparatus 2 include an operation which the service receiving entity performs using the terminal apparatus 2.

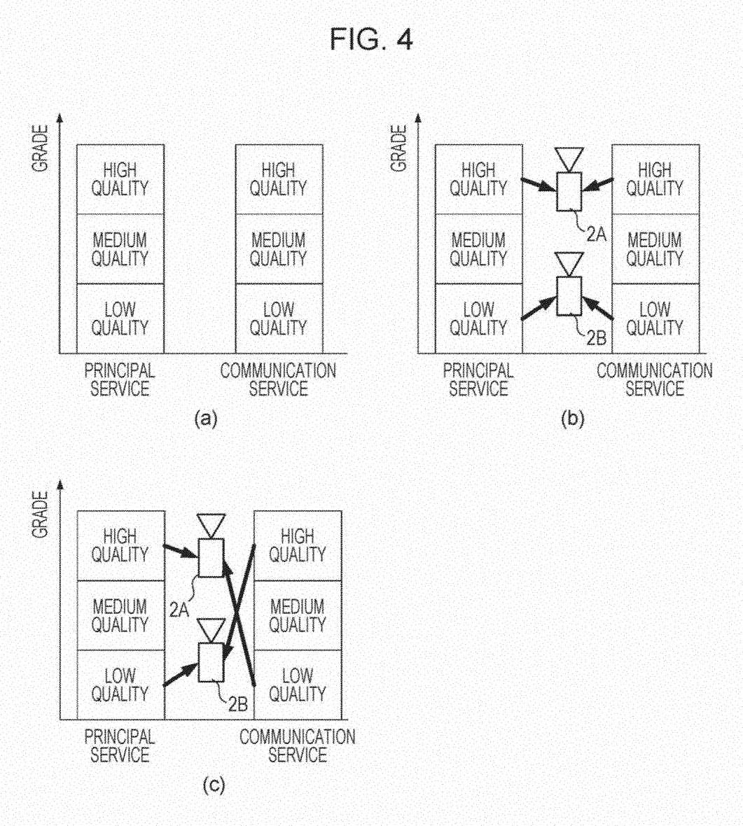

FIG. 4 is schematic diagrams for explaining an example of the present embodiment. As shown in FIG. 4(a), the present embodiment assumes that a service providing entity provides a principal service to a service receiving entity and also provides a communication service. The principal service here is not limited to a particular one, and any business form and any provision method may be adopted. Not that although the communication service is basically assumed to be provided the communication system described in the first embodiment, the communication service is not limited to this. The communication system will be described below with a focus on differences from the first embodiment.

The service providing entity can provide principal services different in service quality to the service receiving entity. The service providing entity can divide principal services into a plurality of categories and configure a grade (a class, a rank, a quality difference, or a level) for each category. By way of example, in FIG. 4(a), principal services are classified into three grades: high quality, medium quality, and low quality. The service receiving entity can receive a principal service with service quality commensurate with a cost by paying the cost to the service providing entity on the basis of the grades configured in advance. The quality of a principal service which the service receiving entity can enjoy generally increases with an increase in a cost which the service receiving entity pays to the service providing entity. Examples of a principal service to be graded include seats in a stadium (an arena, a ball park, a field, a court, a gym, or a pool) and on a traffic facility (a bus, a railway, a bullet train, an airplane, or the like), and other seats, a room at an accommodation facility, and a meal at a restaurant.

The communication system according to the present embodiment assumes that the service receiving entity includes the terminal apparatus 2, and the base station apparatus 1A allocates resources to the terminal apparatus 2 on the basis of a cost paid for a principal service by the service receiving entity. The expression “the terminal apparatus 2 pays a cost for a principal service” will be used below. The expression is synonymous with the expression “a service receiving entity including the terminal apparatus 2 pays a cost for a principal service”. The both expressions will be used below without any special distinction. In the following, the expression “the service providing entity provides a communication service to the service receiving entity” and the expression “the base station apparatus 1A provides a communication service to the terminal apparatus 2” are assumed to be synonymous. When special distinction is needed, a description to that effect is given.

Like the first embodiment, the base station apparatus 1A can allocate resources to a terminal apparatus 2A and a terminal apparatus 2B. For example, when the base station apparatus 1A is to allocate time resources to the terminal apparatuses 2A and 2B, the base station apparatus 1A can allocate time resources while giving priority to the terminal apparatus 2A over the terminal apparatus 2B. Here, the communication system and the base station apparatus 1A can manage a difference in communication quality caused by a resource allocation method as communication quality grades. Taking the case described earlier as an example, a communication service received by the terminal apparatus 2A, to which time resources are allocated while priority is given, can be said to be high in communication quality grade. On the other hand, a communication service received by the terminal apparatus 2B, to which time resources are not allocated while priority is given, can be said to be low in communication quality grade. That is, resource allocation to the terminal apparatuses 2 by the base station apparatus 1A can mean that the base station apparatus 1A configures grades for communication services (communication services are also classified into high quality, medium quality, and low quality in FIG. 4(a), like principal services) and the base station apparatus 1A provides communication services different in grade to the terminal apparatuses 2, as shown in FIG. 4(a).

Here, a method for configuring a grade for a communication service by the base station apparatus 1A is not limited to a particular one. As described above, the base station apparatus 1A can determine a communication service grades on the basis of resources (time resources (an occupied time and an allocation period), frequency resources (an occupied bandwidth, a frequency hopping pattern, and a carrier frequency), code resources (a spread code and a spread code generation parameter), and space resources (an antenna port number, a beam identification number, and a precoding identification number)) allocated to the terminal apparatuses 2A and 2B. Since there is a limit to resources of the communication system, if the base station apparatus 1A allocates the resources to the particular terminal apparatus 2 while giving priority to the terminal apparatus 2, the base station apparatus 1A can be regarded as providing a communication service high in grade to the terminal apparatus 2.

The base station apparatus 1A can determine a communication service grade in accordance with communication quality to be provided to each of the terminal apparatuses 2A and 2B. For example, the base station apparatus 1A can determine a communication service grade in accordance with a data rate to be provided to each of the terminal apparatuses 2A and 2B. The base station apparatus 1A can configure a high grade for a communication service with a high data rate. The base station apparatus 1A can also determine the grade of communication service in accordance with the service quality (communication speed quality) of the communication service. For example, the base station apparatus 1A is capable of providing two communication services, a communication service which guarantees a minimum communication speed and a best-effort communication service, the base station apparatus 1A configures the communication service guaranteeing the minimum communication speed such that the communication service has a high grade and configures the best-effort communication service such that the communication service has a low grade.

The base station apparatus 1A can determine a communication service grade in accordance with latency for communication to be provided to each of the terminal apparatuses 2A and 2B. Here, latency includes all times required for the terminal apparatus 2A to communicate, such as time from when the terminal apparatus 2A starts a procedure for connection to the base station apparatus 1A to when the terminal apparatus 2A actually starts data transmission, and a time required to transmit all data to the base station apparatus 1A from when data traffic is generated in the terminal apparatus 2A. The base station apparatus 1A can provide a communication service with short latency as a high-grade communication service to the terminal apparatus 2A.

The base station apparatus 1A can determine a communication service grade in accordance with a RAT, by which each of the terminal apparatuses 2A and 2B is to be accommodated. For example, if the base station apparatus 1A is capable of accommodating the terminal apparatuses 2A and 2B using two RATs, a centralized controlled RAT (for example, LTE) and a decentralized control RAT (for example, a WLAN), the base station apparatus 1A configures a communication service using the centralized control RAT such that the communication service has a high grade and configures a communication service using the decentralized control RAT such that the communication service has a low grade.

The base station apparatus 1A can determine the grade of a communication service in accordance with a frequency band used in the communication service. For example, if the base station apparatus 1A is capable of providing a communication service using a frequency band called a licensed band which needs permission of use from a country or a territory providing a service and a communication service using a frequency band called an unlicensed band which does not need permission of use from a country or a territory providing a service, the base station apparatus 1A can configure the communication service using the licensed band such that the communication service has high grade and configure the communication service using the unlicensed band such that the communication service has a low grade.

The base station apparatus 1A can determine a communication service grade depending on a principal service to be provided to each of the terminal apparatuses 2A and 2B using communication. For example, assume a case where a service providing entity provides a principal service which distributes pictures of cameras arranged at a plurality of sites to the terminal apparatuses 2A and 2B, using communication. In this case, radio resources needed by the base station apparatus 1A change depending on the number of camera pictures (the number of viewpoints or the number of free viewpoints) to be distributed to the terminal apparatus 2A. To provide a larger number of camera pictures, more radio resources are needed naturally. Thus, the base station apparatus 1A can determine the grade of a communication service to be provided to the terminal apparatus 2A in accordance with the number of free viewpoints to be provided to the terminal apparatus 2A.

FIG. 4(b) is a schematic diagram showing an example of resource allocation by the base station apparatus 1A according to the present embodiment. The base station apparatus 1A can allocate resources to the terminal apparatus 2 high in a cost paid for a principal service while giving priority to the terminal apparatus 2. For example, in FIG. 4(b), the terminal apparatus 2A that is provided with a high-quality principal service can be allocated time resources by the base station apparatus 1A while the terminal apparatus 2A is given priority over the terminal apparatus 2B. The example in FIG. 4(b) shows that the quality of a communication service which each of the terminal apparatuses 2A and 2B obtains from the base station apparatus 1A (or the communication system) increases with an increase in a cost paid for a principal service by the terminal apparatus 2A or 2B.

A communication quality grade may be determined by the communication system or the base station apparatus 1A, or may be determined by an entity which provides a service using the communication system as in the case of a principal service. A communication quality grade is not uniquely fixed and can be determined in accordance with a communication service provided by the communication system. For example, the grade of communication quality can be assumed to be high if a maximum communication speed is high, or the grade of communication quality can be assumed to be high if a prescribed communication speed is guaranteed. The base station apparatus 1A can provide a communication service with high-grade communication quality to the terminal apparatus 2 that has paid a high cost. The base station apparatus 1A can provide a communication service with high-grade communication quality to the terminal apparatus 2 that has paid a cost higher than a prescribed cost. The base station apparatus 1A can configure more than two communication quality grades. The base station apparatus 1A may determine a communication quality grade depending simply on whether a communication speed is high or low and can determine a communication quality grade on the basis of various requests (a maximum communication speed, a minimum guaranteed communication speed, a communication opportunity capture rate, reception quality, transmission quality, an allowable call number, an allowable transmission traffic amount, an allowable reception traffic amount, an allowable continuous communication time, and the like) from the terminal apparatus 2. The base station apparatus 1A can configure a cost for each communication quality grade in accordance with the performance of the own apparatus and a communication environment.

FIG. 4(c) is a schematic diagram showing an example of resource allocation by the base station apparatus 1A according to the present embodiment. As shown in FIG. 4(c), the terminal apparatus 2 according to the present embodiment can pay separate costs for a principal service and a communication service. For example, the terminal apparatus 2A can pay a high cost for a principal service and pay a low cost for a communication service. The terminal apparatus 2B can pay a low cost for a principal service and a high cost for a communication service. The base station apparatus 1A can determine resource allocation to the terminal apparatus 2 not on the basis of a cost paid for a principal service by the terminal apparatus 2 but on the basis of a cost paid for a communication service by the terminal apparatus 2. Taking the case described earlier as an example, the terminal apparatus 2B can receive a communication service with high-grade communication quality even though the grade of a principal service is low. In contrast, the terminal apparatus 2A receives a communication service with low-grade communication quality even though the grade of a principal service is high.

The terminal apparatus 2 can determine a cost to be paid for a communication service when the terminal apparatus 2 pays a cost for a principal service (expresses its intention to pay the cost). For example, if the base station apparatus 1A determines a communication quality grade for a communication service to be provided to the terminal apparatus 2 on the basis of the grade of a principal service, the terminal apparatus 2 can determine a communication quality grade for a communication service which the own apparatus can receive by determining a cost to be paid for a principal service.

If the base station apparatus 1A determines a communication quality grade for a communication service to be provided to the terminal apparatus 2 on the basis of not only the grade of a principal service but also a cost paid for a communication service by the terminal apparatus 2, the terminal apparatus 2 can determine a cost to be paid for a principal service and determine a cost to be paid for a communication service independently.

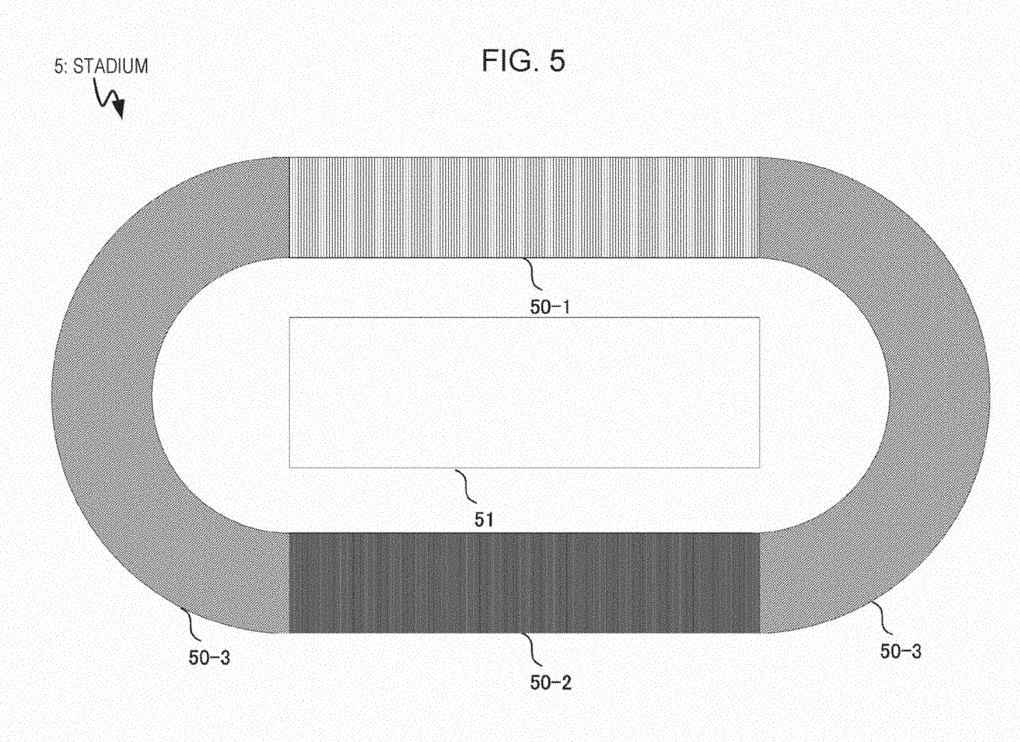

The base station apparatus 1A can determine resources to be allocated to the terminal apparatus 2 not on the basis of a cost paid by the terminal apparatus 2 but simply on the basis of a principal service received by the terminal apparatus 2. For example, if the base station apparatus 1A includes a plurality of beams as space resources, since the angle and distance between the base station apparatus 1A and a seat for a spectator are uniquely fixed in a stadium as shown in FIG. 5, an optimum beam for the terminal apparatus 2 present in the seat for a spectator is fixed naturally. Thus, the base station apparatus 1A can determine a beam to be allocated to the terminal apparatus 2 on the basis of information on the seat for a spectator provided to the terminal apparatus 2 by a principal service.

Available grades for a communication service can be changed depending on the grade of a principal service. For example, if the grade of a principal service is a high-quality grade, a choice can be made among high-quality, medium-quality, and low-quality communication services. On the other hand, if the grade of the principal service is a low-quality grade, a choice can be made among medium-quality and low-quality communication services.

The base station apparatus 1A that has been described above can be said to be capable of setting up a part of a configuration regarding a communication service to be provided to the terminal apparatus 2 prior to the start of the communication service. For example, the base station apparatus 1A can set up, in advance, a part of a configuration regarding a communication service which is determined on the basis of information (for example, higher layer signaling) exchanged at a higher layer before communication at the physical layer with the terminal apparatus 2, prior to the start of the communication service.

According to the base station apparatus 1A and the terminal apparatus 2 described above, the terminal apparatus 2 can select communication quality for a communication service which the own apparatus is to receive in association with the service quality of a principal service received by the own apparatus. Meanwhile, the base station apparatus 1A can determine communication quality (for example, resource allocation) for a communication service to be provided to the terminal apparatus 2 in association with the grade of the service quality of a principal service. Since the base station apparatus 1A can flexibly and easily determine resource allocation, it is possible to effectively utilize resources and, in turn, contribute to an improvement in the spectral efficiency of the communication system.

### 2.1. First Modification

FIG. 5 is a schematic diagram showing an example of the embodiment according to the present modification. In the present modification, an entity which provides a principal service includes a stadium 5 as shown in FIG. 5. The stadium 5 further includes seats 50-1, 50-2, and 50-3 and a playing field 51. Hereinafter, the seats 50-1, 50-2, and 50-3 are also collectively referred to as seats 50. Each seat 50 can further include a plurality of seats (stands or seats to watch) within its range shown in FIG. 5. The entity providing the principal service provides the seat 50 within the stadium 5 to an entity which receives the principal service (or the terminal apparatus 2 that the service receiving entity includes). The stadium 5 further includes a communication system which includes the base station apparatus 1A and the terminal apparatus 2.

The entity providing the principal service can give a grade to each seat 50. Here, the entity providing the principal service has grades S, A, and B in descending order and can configure the seats 50-1, 50-2, and 50-3 such that seats 50-1, 50-2, and 50-3 are given grade S, grade A, and grade B, respectively. The grades here can be configured by the entity providing the principal service on the basis of various factors, such as the material for each seat, a distance to the playing field 51, and exposure to the sun. The entity receiving the principal service can receive a seat with a grade commensurate with a cost paid to the entity providing the principal service.

In the present modification, the base station apparatus 1A can determine resource allocation to the terminal apparatus 2 on the basis of the grade of a seat acquired by the terminal apparatus 2.

For example, the base station apparatus 1A can configure a grade for a communication service to be provided to the terminal apparatus 2, like the grades configured for the seats 50. For example, the base station apparatus 1A can configure the three grades, S, A, and B for communication services in descending order of quality. The base station apparatus 1A can provide a communication service with the same grade as that of a seat acquired by the terminal apparatus 2 to the terminal apparatus 2.

For example, the number of free viewpoints obtained by the terminal apparatus 2 can be configured as a grade for a communication service to be provided to the terminal apparatus 2 by the base station apparatus 1A. The terminal apparatus 2 can acquire pictures photographed by a plurality of cameras arranged within the stadium 5 using a communication service. The number of free viewpoints here can be regarded as the number of pictures from cameras which the terminal apparatus 2 can acquire at one time. To obtain a plurality of free viewpoints, the terminal apparatus 2, of course, needs to be provided with a communication service with high communication quality. Thus, the base station apparatus 1A can perform control so as to provide many free viewpoints to the terminal apparatus 2, to which a high-grade communication service is provided, and provide a few free viewpoints to the terminal apparatus 2, to which a low-grade communication service is provided.

Note that, as described earlier, the terminal apparatus can pay separate costs to a principal service and a communication service. In this case, the base station apparatus 1A does not depend on the grade of the seat 50 acquired by the terminal apparatus 2 and can determine quality for a communication service to be provided to the terminal apparatus 2 on the basis of a cost paid for a communication service by the terminal apparatus 2.

### 2.2. Second Modification

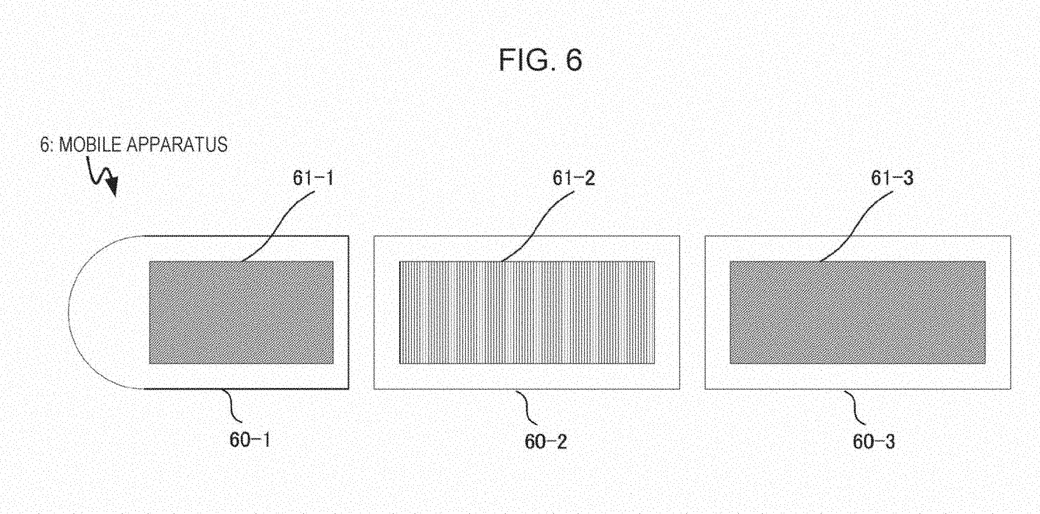

FIG. 6 is a schematic diagram showing an example of the embodiment according to the present modification. In the present modification, an entity which provides a principal service includes a mobile apparatus 6, typified by a train, as shown in FIG. 6. The mobile apparatus 6 includes train cars 60 (including a train car 60-1, a train car 60-2, and a train car 60-3). The train cars 60 include seats 61 (a seat 61-1, a seat 61-2, and a seat 61-3). The mobile apparatus 6 further includes a communication system including the base station apparatus 1A and the terminal apparatus 2. The entity providing the principal service can provide the principal service to an entity which receives the principal service by providing the seat 61 to the entity receiving the principal service. The entity providing the principal service can provide a communication service to the entity receiving the principal service using the communication system.

The entity providing the principal service can give a grade to each seat 61, as shown in FIG. 6. For example, the seat 61-2 is a seat (reserved seat) which is reserved in advance by the service receiving entity, and the seats 61-1 and 61-3 are seats (unreserved seats) which are not reserved in advance by the service receiving entity. That is, the entity providing the principal service configures a high grade for the seat 61-2 and a low grade for the seats 61-1 and 61-3. Of course, the service receiving entity needs to pay a higher cost to the service providing entity to acquire the seat 61-2 than to acquire the seat 61-1 or 61-3.

In the present modification, the base station apparatus 1A can determine a grade for a communication service to be provided to the terminal apparatus 2 on the basis of the grade of a seat acquired by the terminal apparatus 2. That is, the base station apparatus 1A can provide, to the terminal apparatus 2 that has acquired the high-grade seat 61-2, a high-grade communication service (for example, the base station apparatus 1A allocates time resources to the terminal apparatus 2 while giving priority to the terminal apparatus 2). Note that the terminal apparatus 2 can separately pay costs to a principal service and a communication service, like the first modification. In this case, the base station apparatus 1A can determine a grade for a communication service to be provided to the terminal apparatus 2 on the basis of a cost paid for communication service by the terminal apparatus 2.

### 2.3. Third Modification

The present modification assumes a case where a principal service which a service providing entity provides is a transportation infrastructure, such as a limited highway. Like the modifications described earlier, the transportation infrastructure includes communication system including the base station apparatus 1A and the terminal apparatus 2. The service providing entity can provide a communication service to the terminal apparatus 2 that service receiving entity includes, using the communication system in addition to the transportation infrastructure as the principal service.

In the present modification, a cost paid for the principal service by the terminal apparatus 2 includes a time duration for which the terminal apparatus 2 utilizes the principal service (limited highway). For example, the service receiving entity can utilize the limited highway by paying a cost to the service providing entity. If the number of terminal apparatuses 2 using the limited highway is large (for example, in the event of traffic congestion on the limited highway), the transportation infrastructure bears a load, the amount of which is more than a cost paid for the principal service by the terminal apparatus 2. In this case, the cost payed for the principal service by the terminal apparatus 2 can be said to be low. For this reason, the base station apparatus 1A can decrease the grade of communication service which is provided to the entity receiving the principal service for a time duration with a load on the principal service. On the other hand, the base station apparatus 1A can increase the grade of the communication service to be provided to the entity receiving the principal service for a time duration with no load on the principal service.

If the number of terminal apparatuses 2 using the limited highway is large, the terminal apparatus 2 can be considered to be receiving a principal service with a grade lower than a grade commensurate with the cost paid for the principal service from the service providing entity. In this case, the base station apparatus 1A can increase the grade of a communication service to be provided to the entity receiving the principal service for a time duration with a load on the principal service. On the other hand, the base station apparatus 1A can decrease the grade of the communication service to be provided to the entity receiving the principal service for a time duration with no load on the principal service.

### 3. Third Embodiment

In the present embodiment, resources to be allocated to a terminal apparatus 2, a RAT to be used, and service quality to be provided, which are determined by a base station apparatus 1A, are exchanged with the terminal apparatus 2 with high efficiency. Note that the apparatus constitutions of the base station apparatus 1A and a terminal apparatus 2A are the same as those in the first embodiment. Although the following description is given with a case where the base station apparatus 1A allocates resources to the terminal apparatus 2 in mind, a method according to the present embodiment is, of course, not limited to this.

The base station apparatus 1A according to the present embodiment can determine resources to be allocated to the terminal apparatus 2 by the methods described in the first and second embodiments. The terminal apparatus 2 can change a configuration for the own apparatus in accordance with resources allocated to the own apparatus by the base station apparatus 1A. For example, the terminal apparatus 2 can change a configuration when a reception unit 204 demodulates a desired signal from a received signal (for example, a configuration for resource information allocated to the PDSCH addressed to the own apparatus).

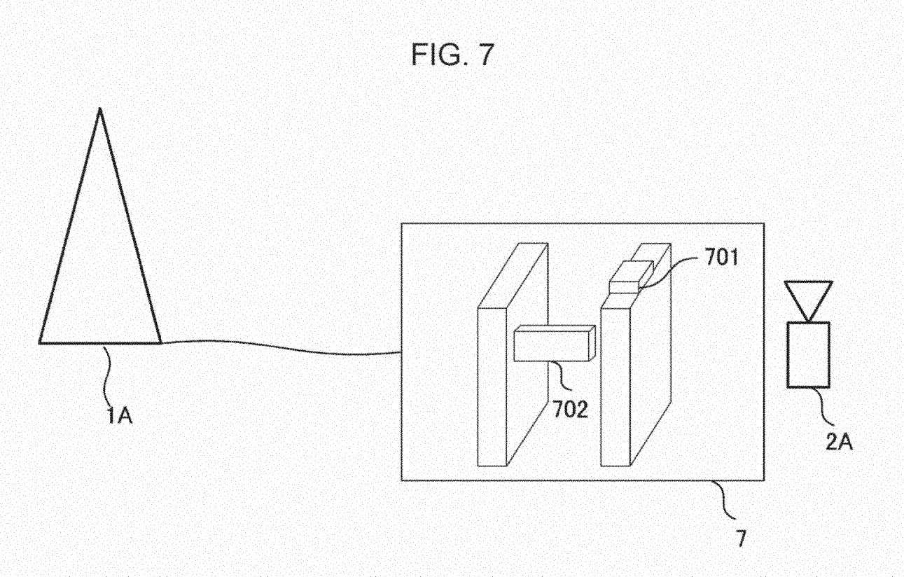

FIG. 7 is a schematic diagram showing an example of a communication system according to the present embodiment. As shown in FIG. 7, the example of the communication system according to the present embodiment includes the base station apparatus 1A, the terminal apparatus 2A, and a gate system 7. The gate system 7 further includes an information read/write apparatus 701 and a gate 702. The base station apparatus 1A and the gate system 7 are capable of exchanging information with each other over, for example, a wired network. Note that the base station apparatus 1A may have the capability of the gate system 7.

The terminal apparatus 2A or a service receiving entity which includes the terminal apparatus 2A is assumed to pass through the gate system 7. For example, the information read/write apparatus 701 that the gate system 7 includes reads information from the terminal apparatus 2A, and the gate system 7 controls opening and closing of the gate 702 on the basis of the information.

The base station apparatus 1A according to the present embodiment can determine resources to be allocated to the terminal apparatus 2A on the basis of the information read from the terminal apparatus 2A by the information read/write apparatus 701. The information read from the terminal apparatus 2A by the information read/write apparatus 701 here refers to, for example, information associated with a cost paid by the terminal apparatus 2A for a communication service provided by the base station apparatus 1A, as described in the second embodiment.

The base station apparatus 1A can notify the gate system 7 of information associated with resources allocated to the terminal apparatus 2A. Since the terminal apparatus 2A can acquire the information associated with the resources allocated to the own apparatus by the base station apparatus 1A from the read/write apparatus 301, the terminal apparatus 2A can change a configuration for the own apparatus on the basis of the information.

A method by which the terminal apparatus 2A notifies the base station apparatus 1A of information associated with a cost paid for a communication service provided by the base station apparatus 1A is not limited to the form as shown in FIG. 5. For example, a portable device having the capability of the information read/write apparatus 701 of the gate system 7 can also be used.

The gate system 7 also includes means for authenticating the terminal apparatus 2A. For example, the gate system 7 is capable of opening the gate 702 only when the terminal apparatus 2 authenticated by a service providing entity intrudes into the gate system. For example, the communication system according to the present embodiment can further include an authentication server. Information on the terminal apparatus 2 already authenticated by the service providing entity is stored in the authentication server, and the gate system 7 can judge whether the terminal apparatus 2 passing through the own apparatus is authenticated by the service providing entity, by reading the information stored in the authentication server. The gate system can provide, to the terminal apparatus 2, information on a communication service provided by the base station apparatus 1A (for example, information on radio resources allocated to the terminal apparatus 2) simultaneously with an authentication procedure for the terminal apparatus 2 passing through the own apparatus based on the information stored in the authentication server.

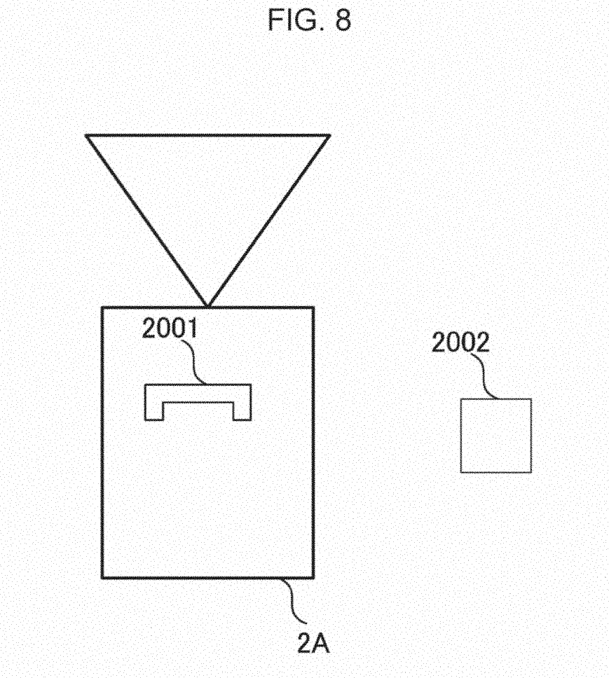

FIG. 8 is a schematic diagram showing an example of the terminal apparatus 2A according to the present embodiment. As shown in FIG. 6, the terminal apparatus 2A according to the present embodiment includes a card slot 2001. An integrated circuit (IC) card 2002 can be inserted into the card slot 2001. The IC card bears configuration information regarding communication for the terminal apparatus 2A. The terminal apparatus 2A can perform communication by reading the information from the IC card. For example, a subscriber identity module (SIM) card can be used as the IC card 2002.

The base station apparatus 1A according to the present embodiment or an entity which provides a communication service using the base station apparatus 1A can distribute the IC card 2002 bearing information or resources allocated to the terminal apparatus 2A to the terminal apparatus 2A. The terminal apparatus 2A can read the information on the resources allocated to the own apparatus and change a configuration for the own apparatus by inserting the IC card 2002 distributed from the base station apparatus 1A into the card slot 2001 of the own apparatus. In the terminal apparatus 2A, the IC card may be inserted into the card slot 2001 after the IC card 2002 that is already inserted in the card slot 2001 of the own apparatus and is different from the IC card is removed. The terminal apparatus 2A can include a plurality of card slots 2001 and a plurality of IC cards including the IC card.

An entity which provides a principal service different from a communication service can include the IC card in media used for the principal service. For example, the entity providing the principal service can include the IC card in media (authentication media, such as an admission ticket and a passport) to be distributed to an entity which receives the principal service. The entity providing the principal service can use the IC card as an authentication medium to be distributed to the entity receiving the principal service.

The entity providing the principal service different from a communication service can put information associated with resources to be allocated to the terminal apparatus 2A by the base station apparatus 1A on a medium used for the principal service. For example, the entity providing the principal service can put information associated with resources allocated to the terminal apparatus 2A by the base station apparatus 1A (for example, a two-dimensional barcode representing resource allocation information) on an authentication medium (for example, an admission ticket) to be distributed to the entity receiving the principal service. The terminal apparatus 2A (or an entity including the terminal apparatus 2A which receives a principal service or a communication service) can read the information from the admission ticket bearing the information and change a communication configuration for the own apparatus on the basis of the read information. The terminal apparatus 2A can also acquire information associated with resources allocated to the own apparatus by the base station apparatus 1A on the basis of authentication information (for example, a uniform resource locator (URL) from which the information can be downloaded) described in the information.

Note that an entity which provides a principal service or a communication service can provide the service to a service receiving entity not on a one-off contract but on a continuing contract. For example, an entity which provides a principal service can provide the service to a service receiving entity on a yearly contract. In this case, also for an associated communication service, the entity providing the principal service can provide the communication service on a yearly contract. In this case, the base station apparatus 1A that provides the communication service can use a method for allocating resources to the terminal apparatus 2A to be provided with the communication service (for example, a method by which the base station apparatus 1A accommodates the terminal apparatus 2A using a prescribed RAT or a method by which the base station apparatus 1A allocates time resources for a prescribed period to the terminal apparatus 2A) during a contract period. Thus, the terminal apparatus 2A can determine a communication configuration on the basis of the method, by which the base station apparatus 1A allocates resources to the terminal apparatus 2A, during the contract period.

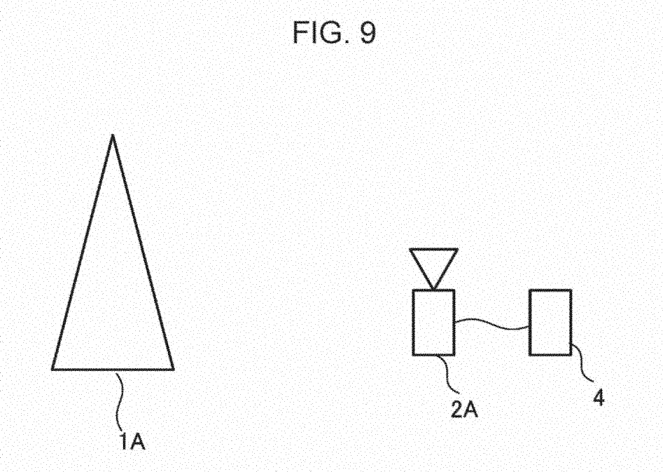

FIG. 9 is a schematic diagram showing an example of the communication system according to the present embodiment. As shown in FIG. 9, the communication system according to the present embodiment can include the base station apparatus 1A, the terminal apparatus 2A, and a communication device 4. The communication device 4 can exchange information with the terminal apparatus 2A via some communication medium (wired communication by wired cable or radio communication by a RAT, such as Bluetooth®).

The communication device 4 may have any shape as long as the communication device 4 fulfills the capabilities to be described below. For example, the communication device 4 may have the shape of a jacket so as to preserve an outer appearance of the terminal apparatus 2A.

The base station apparatus 1A can put information associated with resources allocated to the terminal apparatus 2A on the communication device 4 and distribute the communication device 4 to the terminal apparatus 2A. Since the terminal apparatus 2A can acquire the information associated with the resources allocated to the own apparatus by the base station apparatus 1A by connecting the communication device 4 to the own apparatus, a configuration for the own apparatus can be changed. The communication device 4 can have at least a part of a communication capability of the terminal apparatus 2A. In this case, the terminal apparatus 2A can execute the part of the communication capability using the communication device 4.

The communication device 4 can also include authentication means for a principal service. For example, a service providing entity can provide the communication device 4 only to the terminal apparatus 2 that is already authenticated for the principal service. That is, the service providing entity can judge that the terminal apparatus 2 including the communication device 4 is authenticated for the principal service. In this case, the terminal apparatus 2A is capable of simultaneously performing an authentication procedure for the principal service and acquiring information on a communication service by including the communication device 4. That is, the communication device 4 also has a capability as an authentication apparatus and the communication device 4 is capable of simultaneously performing a procedure for authenticating the terminal apparatus 2 for the principal service and providing the information on the communication service to the terminal apparatus 2.

As has been described thus far, the terminal apparatus 2A may directly change a configuration regarding communication (specifically, a configuration for the physical layer) by an external device and may change a configuration regarding communication by processing from another layer (for example, the application layer).

The terminal apparatus 2A can include, in advance, an application which fulfills at least a part of the capability to be described below. The base station apparatus 1A (or an entity which provides a communication service using the base station apparatus 1A) can distribute the application to the terminal apparatus 2A.

The base station apparatus 1A and the terminal apparatus 2A can exchange information associated with resources allocated to the terminal apparatus 2A by the base station apparatus 1A, using the application. For example, the terminal apparatus 2A can notify the base station apparatus 1A of information associated with a cost paid for a communication service by the own apparatus, through the application. Meanwhile, the base station apparatus 1A can acquire the information associated with the cost paid for the communication service by the terminal apparatus 2A, notification of which is given by the terminal apparatus 2A, through the application and determine resources to be allocated to the terminal apparatus 2A on the basis of the information. Additionally, the base station apparatus 1A can notify the terminal apparatus 2A of information associated with resources allocated to the terminal apparatus 2A through the application. Since the terminal apparatus 2A can acquire the information associated with the resources allocated to the own apparatus by the base station apparatus 1A through the application, the terminal apparatus 2A can change a configuration regarding communication for the own apparatus on the basis of the information.

According to the base station apparatus 1A and the terminal apparatus 2A that have been described above, the base station apparatus 1A and the terminal apparatus 2A are capable of exchanging information associated with resources allocated to the terminal apparatus 2A by the base station apparatus 1A with high efficiency. Since the base station apparatus 1A can flexibly and easily determine resource allocation, it is possible to effectively utilize resources and, in turn, contribute to an improvement in the spectral efficiency of the communication system.

### 4. Matters Common to All Embodiments

Note that a program running on each of the apparatuses according to the present invention is a program which controls a CPU or the like (a program which causes a computer to function) so as to implement the capabilities of the above-described embodiments of the present invention Information to be handled by the apparatuses is temporarily accumulated in a RAM while being processed, is stored in various types of ROMs or HDDs after that, and is read out by the CPU as needed for modification and writing. Examples of a recording medium storing the program may include semiconductor media (for example, ROM and nonvolatile memory card), optical recording media (for example, a DVD, an MO, an MD, a CD, and a BD), and magnetic recording media (for example, a magnetic tape and a flexible disk). Although the capabilities of the above-described embodiments are implemented by executing a loaded program, the capabilities of the present invention may be implemented by performing processing in cooperation with an operating system, another application program, or the like in accordance with instructions from the program.

When the program is to be distributed to the market, the program stored in a portable recording medium can be distributed or the program can be distributed by being transferred to a server computer connected via a network, such as the Internet. In this case, a storage apparatus of the server computer is also included in the present invention. Further, some or all of the apparatuses in the above-described embodiments may be implemented as an LSI which is typically an integrated circuit. Functional blocks of each apparatus may be made into separate chips or some or all of the functional blocks may be integrated into a chip. In a case where each functional block is integrated into a circuit, an integrated circuit control unit which controls the functional blocks is added.

A technique for circuit integration is not limited to LSI and may be implemented by a dedicated circuit or a general-purpose processor. In a case where circuit integration technology as an alternative to LSI emerges due to the advancement of semiconductor technology, integrated circuits based on the technology can be used.

Note that the present invention is not limited to the above-described embodiments. For example, the terminal apparatus 2 according to the present invention is not limited to application to a mobile station apparatus. The terminal apparatus 2 is, of course, applicable to stationary or immovable electronic devices which are installed indoors or outdoors, such audiovisual devices, kitchen domestic appliances, cleaning and washing devices, air conditioners, office devices, vending machines, and other living devices.

Although the embodiments of the invention have been described in detail with reference to the drawings, a specific constitution of the invention is not limited to the embodiments. A design and the like which do not depart from the spirit of the invention are also included in the claims.

### INDUSTRIAL APPLICABILITY

The present invention is suitably applied to a communication method, an authentication method, a terminal apparatus, a communication system, and an authentication apparatus.

### REFERENCE SIGNS LIST

This International Application is based on and claims priority of Japanese Patent Application No. 2015-075554 filed on Apr. 2, 2015, and the entire contents of Japanese Patent Application No. 2015-075554 are incorporated herein by reference.

1A, 1B base station apparatus

2, 2A, 2B terminal apparatus

4 communication device

5 stadium

50, 50-1, 50-2, 50-3, 61, 61-1, 61-2, 61-3 seat

51 playing field

6 mobile apparatus

60, 60-1, 60-2, 60-3 train car

7 gate system

701 information read/write apparatus

702 gate

101 higher layer processing unit

102 control unit

103 transmission unit

104 reception unit

105 transmit/receive antenna

1011 radio resource control unit

1012 scheduling unit

1031 coding unit

1032 modulation unit

1033 downlink reference signal generation unit

1034 multiplexing unit

1035 radio transmission unit

1041 radio reception unit

1042 demultiplexing unit

1043 demodulation unit

1044 decoding unit

201 higher layer processing unit

202 control unit

203 transmission unit

204 reception unit

205 channel state information generating unit

206 transmit/receive antenna

2011 radio resource control unit

2012 scheduling information analysis unit

2031 coding unit

2032 modulation unit

2033 uplink reference signal generation unit

2034 multiplexing unit

2035 radio transmission unit

2041 radio reception unit

2042 demultiplexing unit

2043 signal detection unit

2001 card slot

2002 IC card

1-15. (canceled)

16. A communication method for providing a communication service associated with a principal service to a terminal apparatus, the communication method comprising:
a step of acquiring a grade of the principal service provided to the terminal apparatus,
a step of determining a grade of the communication service provided to the terminal apparatus on the basis of the grade of the principal service, and
a step of determining a resource to be allocated to the terminal apparatus on the basis of the grade.

17. The communication method according to claim 16, further comprising:
a step of determining a beam to be allocated to the terminal apparatus on the basis of the grades.

18. The communication method according to claim 16, further comprising:
a step of determining a frequency band to be allocated to the final apparatus on the basis of the grades.

19. The communication method according to claim 16, wherein each of the grades is the number of free viewpoints to be provided to the terminal apparatus.

20. The communication method according to claim 16, further comprising:
a step of determining communication speed quality to be provided to the terminal apparatus on the basis of the grade of the communication service.

21. The communication method according to claim 16, further comprising:
a step of determining a RAT, by which the terminal apparatus is to be accommodated, on the basis of the grade of the communication service.

22. The communication method according to claim 16, further comprising:
a step of limiting the number of terminal apparatuses, to which the communication service with a prescribed grade is to be provided, to a prescribed number.

23. An authentication method for authenticating a terminal apparatus, the authentication method comprising:
a step of acquiring a grade of a principal service provided to the terminal apparatus;
a step of determining a grade of a communication service provided to the terminal apparatus on the basis of the grade of the principal service;
a step of determining a resource to be allocated to the terminal apparatus on the basis of the grades;
a step of acquiring information on the communication service based on the principal service, provided to the terminal apparatus;
a step of including the information on the communication service in an IC card that provides information on the principal service to the terminal apparatus;
a step of connecting the IC card to the terminal apparatus; and
a step of providing the information on the communication service to the terminal apparatus from the connected IC card.

24. The authentication method according to claim 23, wherein a gate system is further provided as an authentication medium, and the authentication method further comprises a step in which the information on the communication service is provided from the gate system to the terminal apparatus that is judged by the gate system to be already authenticated.

25. A terminal apparatus for being authenticated for a principal service, the terminal apparatus comprising:
means for connecting an IC card including information on a communication service based on the principal service, and
means for acquiring the information on the communication service based on the principal service on the basis of the IC card.
